(19) United States
(12) Patent Application Publication
(10) Pub. No.: US 2026/0202299 A1
(43) Pub. Date: Jul. 16, 2026

(54) METHOD OF DETERMINING A PARAMETER OF A SAMPLE OF A SUBSTANCE COMPRISING PARTICLES IN A LIQUID

(71) Applicant: FIDA BIOSYSTEMS APS, Søborg (DK)

(72) Inventor: Henrik JENSEN, Søborg (DK)

(73) Assignee: FIDA BIOSYSTEMS APS, Søborg (DK)

(21) Appl. No.: 19/564,332

(22) Filed: Mar. 12, 2026

Related U.S. Application Data
(63) Continuation of application No. PCT/DK2024/050216, filed on Sep. 12, 2024.

(30) Foreign Application Priority Data
Sep. 13, 2023 (DK) PA202370473

(51) Int. Cl. G01N 15/0205; G01N 11/06; G01N 15/00; G01N 15/14

(52) U.S. Cl. CPC G01N 15/0205; G01N 11/06; G01N 15/1459; G01N 2015/0038; G01N 2015/0053

(57) ABSTRACT

A method for determining at least one characteristic parameter of a sample of a substance comprising readable particles in a liquid is disclosed. The method is specifically beneficial where the readable particles comprises a plurality of particle species. The method comprises obtaining Taylor dispersion data comprising a plurality of data sets describing a Taylor dispersion signal profile of the readable particles of the sample; fitting the Taylor dispersion data to a fitting equation (2) Sₜₒₜ(t)=f(p(t); α, β*A+B, wherein Sₜₒₜ(t) is the total signal at the time t, A is a response factor, B is a baseline constant, p(t) is an instrument factor function and α and β are fitting constants; determine at least one of the fitting constants α and β; and determining the at least one characteristic parameter of the sample based on the one or more of the fitting constants α and β.

### TECHNICAL FIELD

The invention relates to a method for analyzing particles in a liquid and determining at least one parameter of particles in a liquid, wherein the particles conveniently comprises two or more particles species, such as particles that differs in at least one chemical or physical property

### BACKGROUND ART

Fully or partly characterization of particles is in many situation highly important. Depending on the purpose and the particles to be analyzed, it may be essential to have reliable information about one or more parameters. There are many prior art methods for performing particle analysis, for analysis of particles in solution a frequently used analysis method involves the use of dynamic light scattering, such as dynamic monochrome (laser) scattering.

Particles in solution are often characterized according to their size. A convenient measure of size is the particle hydrodynamic radius (Rh). Some particles and/or mixtures do not have a single well-defined hydrodynamic radius (Rh) and are best described as having a distribution of hydrodynamic sizes around an average hydrodynamic radius. The size distribution may be determined by a polydispersity index (PDI).

Size and polydispersity may be addressed by different techniques such as Dynamic Light Scattering (DLS), nanoparticle tracing analysis (NTA) as well as separation based methodologies such as size exclusion chromatography (SEC). These methods all have limitation related to sample volume and concentration requirement as well as dynamic range in size and in addition are only applicable for very low PDI's.

DLS and NTA share the common feature that they both are based on measuring particle diffusion, which is subsequently converted into hydrodynamic radius. NTA measured diffusion directly by monitoring particle movement whereas DLS uses particle light scattering to quantify diffusivity. Diffusivity is thus a fundamental mass transport phenomenon that can be observed along a gradient in chemical potential or by monitoring random Brownian motion of particles. NTA and DLS does not provide orthogonal measurement of viscosity.

US2015192507 describes a method of determining the size distribution of a mixture of particles using Taylor dispersion. The method comprises: injecting a sample into a capillary; transporting the sample along the capillary in experimental conditions suited to generate a Taylor dispersion phenomenon; generating a signal characteristic of the Taylor dispersion; processing the signal in order to obtain the experimental Taylor signal; and analyzing the experimental Taylor signal S(t), The analysis step consists of seeking an amplitude distribution P(G(c)) that allows the experimental Taylor signal S(t) to be broken down into a sum or continuum of Gaussian functions by implementing an algorithm consisting of minimizing difference between theoretical signal and observed (measured) signal. The minimization is carried out on an interval of interest of the values of the parameter G(c) that is characteristic of the Gaussian amplitude function P(G(c)).

US2018067901 describes a method of analyzing properties of species within a sample using a Taylor dispersion analysis, wherein the method comprises to fit a multi-component Taylorgram model to Taylorgram data g(t) obtained from the sample, the Taylorgram data comprising a multi-component Taylorgram peak or front. The method comprising: evaluating a value of an integration or a differential of the data; determining the parameter of a component of the multicomponent Taylorgram model, based on an analytical expression that includes the value of the integral or differential of the data, the parameter corresponding with a physical property of a component of the sample from which the Taylorgram data was obtained.

There is still a need for a new and reliable method for determining a parameter of particles dispersed in a liquid, especially where the particles comprises a multitude of particle species.

### DISCLOSURE OF INVENTION

An objective of the present invention is to provide a relatively fast and reliable method for determining a characteristic parameter of particles dispersed in a liquid, wherein the particles comprises a plurality of particle species.

An objective of the present invention is to provide a relatively fast and reliable method for determining a characteristic parameter of a sample comprising particles in a liquid, wherein the particles comprises a plurality of particle species.

In an embodiment, it is an objective to provide a relatively simple method for determining a characteristic parameter of a liquid sample containing particles, such as a characteristic parameter of the particles of the liquid sample based on a Taylor dispersion profile of the particles.

In an embodiment, it is an objective to provide a relatively simple method for determining a characteristic parameter of particles dispersed in a liquid wherein the characteristic parameter comprises a polydispersity index (PDI).

In an embodiment, it is an objective to provide a relatively simple method for determining and optionally optimizing production quality

In an embodiment, it is an objective to provide a relatively simple method for determining and optionally optimizing production quality.

In an embodiment, it is an objective to provide a method that is suitable for assessing immune responses, such as polydispersity and/or (Kd distribution) in anti-drug antibody binding.

In an embodiment, it is an objective to provide a method that is suitable for assessing contamination.

In an embodiment, it is an objective to provide a method that is suitable for assessing evolving over time of particles e.g. in terms of average size and polydispersity.

These and other objects have been solved by the inventions or embodiments thereof as defined in the claims and as described herein below.

It has been found that the inventions or embodiments thereof have a number of additional advantages, which will be clear to the skilled person from the following description.

The method of the invention is a method employing a processor in a fitting process as described herein.

The method of the invention has been found to be surprisingly fast and effective for determining one or more characteristic parameters of a sample of a substance comprising readable particles in a liquid, wherein the readable particles comprises a plurality of particle species.

The method comprises
generating Taylor dispersion data comprising a plurality of data sets describing a Taylor dispersion signal profile of the readable particles of the sample;
fitting the Taylor dispersion data to a fitting equation 2:

$${S}_{tot} ( t ) = f ( p ( t ) ; α , β ) * A + B \qquad ( 2 )$$

wherein Sₜₒₜ(t) is the total signal at the time t, A is a response factor, B is a baseline constant, p(t) is an instrument factor function and α and β are fitting constants;
determine at least one of the fitting constants α and β; and determining the at least one characteristic parameter of the sample based on the one or more of the fitting constants α and β.

The fitting is performed using a computer. Such as at least one processor.

The Taylor dispersion data may be obtained by performing a Taylor Dispersion Analysis (TDA) to obtain a taylorgram, herein also referred to as a Taylor dispersion signal profile.

A Taylor Dispersion Analysis (TDA) is a well-known method for the determination of the diffusion coefficient and, thus, the hydrodynamic radius of a particle species. TDA is based on the dispersion of a sample plug containing the particle species e.g. between buffer plugs in a narrow channel under a laminar Poiseuille flow (pressure induced flow). The dispersion is due to the combined action of the dispersive parabolic velocity profile and the molecular diffusion of the particle species that redistributes the molecules in the cross-section of the channel. The Taylor dispersion signal profile may be recorded as a function of time (t).

The phrase “molecular interaction” means any non-covalent interactions between molecules and/or particles as well as interactions within one or more molecules and/or particles, such as protein folding.

The invention is directed to improving a physical measurement technique with the objectives as mentioned above. The measurement technique is specifically applicable for polydisperse particle systems and involves a transformation of experimentally obtained Taylor dispersion data.

The term “particle” is herein used to mean any portion of matter comprising at least one molecule, such as an organic molecule or an inorganic molecule. The particle may for example comprise an aggregate, a cluster, a complex or any combinations comprising one or more of these.

The term “binding partner” is herein used to mean any molecule or group of molecules, capable of non-covalent interacting with the particle.

The term “marker” is herein used to mean any intrinsic or extrinsic marker capable of being detected by a reader arrangement. In an embodiment, the marker comprises an element, group of elements, moieties and/or any combination comprising one or more of these, where the marker is capable of being detected by a reader arrangement directly and/or after being influenced from an external and/or internal source.

The term “marker” and “label” and derivatives thereof are used interchangeable.

The term “reader arrangement” means any detector or detector system capable of detection a signal associated with the binding partner and/or particle, such as an optical signal and/or an electrochemical signal.

The term “buffer” means an aqueous solution, which is resistant to changes in pH value in the context where the buffer is used. The buffer advantageously comprises an aqueous solution of either a weak acid and its salt or a weak base and its salt.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

Reference made to “some embodiments” or “an embodiment” means that a particular feature(s), structure(s), or characteristic(s) described in connection with such embodiment(s) is included in at least one embodiment of the subject matter disclosed. Thus, the appearance of the phrases “in some embodiments” or “in an embodiment” in various places throughout the specification is not necessarily referring to the same embodiment(s). Further, the skilled person will understand that particular features, structures, or characteristics may be combined in any suitable manner within the scope of the invention as defined by the claims.

Throughout the description or claims, the singular encompasses the plural unless otherwise specified or required by the context.

Unless other is specified, any properties, ranges of properties and/or determination and/or assay condition is given or provided at 37° C.

Unless other is specified, any properties, ranges of properties and/or determination and/or assay condition is given or provided at 1 atmosphere except for an optional pressure applied for ensuring a laminar flow of the sample in a channel.

All features of the invention and embodiments of the invention as described herein, including ranges and preferred ranges, may be combined in various ways within the scope of the invention, unless there are specific reasons not to combine such features.

It has been found that the method may combine determining size of a particle and simultaneously determine the particle distribution and average size of another particle.

Whereas it is known that a plurality of particle species in a liquid may have different diffusivities due to different sizes, the inventors of the present invention have now discovered that a very accurate and relatively fast determination of one or more characteristic parameters of a liquid substance comprising a plurality of particle species may be determined based on the assumption that the diffusivities D of the particle species are gamma distributed. In addition, the inventor have discovered that the inverse diffusivities 1/D may be assumed to be inverse gamma distributed and/or in the alternative the diffusivities D may be assumed to be inverse gamma distributed. The physical discovery that diffusivities follow gamma distributions under Taylor dispersion conditions has led to the invention comprising the practical instrument based application as defined in the claims.

Heretofore, the present invention, it has never been considered that the diffusivities D of particle species in a liquid substance may be considered to be gamma distributed or that the inverse diffusivities 1/D of particle species in a liquid substance may be considered to be inverse gamma distributed. Thus, in the prior art it has been difficult or very cumbersome to determine at least some characteristic parameters of a liquid substance comprising a plurality of particle species, in particular where the plurality of particle species comprises more than two particle species, such as more than 3, such as 5 or more particle species. For example, it has not previously been possibly to determine a PDI above 0.3, such as above 0.4 with a desired high accuracy.

The method of the invention thereby provide an improved method for determining the at least one characteristic parameter.

The realization that the diffusivities D of particle species in a liquid substance may be considered to be gamma distributed and/or that the inverse diffusivities 1/D of particle species in a liquid substance may be considered to be inverse gamma distributed has opened up for a determination of characteristic parameter with surprisingly high accuracy even where the particle species comprises a relatively high number of particle species, such a 5 or more, such as 10 or more.

Thereby by fitting the Taylor dispersion data to the fitting equation 2, such as the fitting equation 3, the at least one characteristic parameter of the sample may be determined in a relatively simple and fast manner.

The method of the invention is in practice a computer implemented invention requiring the use of a computer, e.g. one or more processors for performing at least the fitting(s). In an embodiment, the method comprises determining the dynamic viscosity n and optionally calculation of average particle size.

In an embodiment, the method comprises determining of average particle size and PDI, which may for example be determined even for a heavily aggregated sample.

In accordance with the invention, the method comprises obtaining Taylor dispersion data describing a Taylor dispersion signal profile of the readable particles of the sample. The Taylor dispersion signal profile may advantageously be obtained by performing a Flow-Induced Dispersion Analysis (FIDA). The Taylor dispersion data may be provided by the raw determined data sets and/or the Taylor dispersion data may be extracted from a Taylor dispersion signal profile.

Methods and systems for performing FIDA for generating Taylor dispersion signal profiles are for example described in US2013059313, US2023132619, WO22237946 or WO23025364.

In FIDA, a particle concentration gradient of a sample may be measured by an adequate detector such as an optical detector. The concentration gradient may conveniently be read at a single location along of a flow channel during laminar flow of the sample within the channel. The Taylor dispersion signal profile is a profile of the signal as a function of time (Sₜₒₜ(t)). The read signal profile may be used to quantify diffusivity and thereby molecular size. In general, the concentration gradient of a particle species read for example by reading a marker of the particle species e.g. a fluorescence marker at a single point over time may be described as Si(t). On the other hand, if the sample is polydisperse and comprises two or more particle species, the total signal measured will be composed of signals read from a continuous or finite ensemble of the two or more species or particles with different diffusivities. The total signal may be termed Sₜₒₜ(t) and described as equation 1:

$${S}_{tot} ( t ) = {\int }_{0}^{∞} S ( t ) d {D}_{i} \qquad ( 1 )$$

Where the diffusivity is treated as an integration variable. Di is thus the diffusivity of the particle species i in the ensemble.

While equation 1 may be a general way of describing the concentration gradient of a polydisperse sample subject to net diffusion it is challenging to provide particular determination based on that equation 1, as there are no general solutions for Si(t).

According to the invention, it has been found that the concentration distribution of the plurality of particle species following a laminar hydrodynamic flow as in FIDA may be describes as the sum of the Gaussian distributions of the respective particle species, which may be represented by a Gamma distribution. Based on this it has been realized that by fitting the Taylor dispersion signal profile to the fitting equation 2:

$${S}_{tot} ( t ) = f ( α , β , p ( t ) ) * A + B \qquad ( 2 )$$

wherein Sₜₒₜ(t), t, may be as stated above, A is a response factor and B is the detector (instrument) offset/constant, p(t) is a function describing dispersion and α and β are fitting constants herein also referred to as gamma constants based on the above realization that the diffusivities D may be assumed to be gamma distributed and the inverse diffusivities 1/D may be assumed to be inverse gamma distributed or in addition or in the alternative the diffusivities D may be assumed to be inverse gamma distributed and/or the inverse diffusivities 1/D may be assumed to be gamma distributed.

In practice it has been found that whether the diffusivities D may be assumed to be gamma distributed or inverse gamma distributed the provided equation may be applied in the same way whether the inverse diffusivities 1/D may be assumed to be gamma distributed or inverse gamma distributed.

One or more characteristic parameters of the sample may be determined. As described further below the at least one characteristic parameter may advantageously be determined based on a determination of one or more of the fitting constants α and β.

It has been found that the fitting constants α and β may be treated as constants of a gamma distribution for the Taylor dispersion data wherefore these constants are also referred to as gamma constants. This lead to a simple and effective method of determining the at least one characteristic parameter.

Each of the plurality of data sets of the Taylor dispersion data conveniently describes a total signal at the time t (Sₜₒₜ(t)) of the Taylor dispersion signal profile. Preferably the plurality of data sets comprises at least 3 data sets, such as at least 5 data sets, such as at least 10 data sets or more, preferably the data sets comprises at least 1 Hz (1 data set per second), such as 5 to 12 Hz of data sets.

In a preferred embodiment, the distribution of diffusivities D or inverse diffusivity 1/D is represented by respectively a gamma distribution or an inverse gamma distribution leading to the fitting equation 3:

$${S}_{tot} ( t ) = A \cdot {( \frac{β}{β + p ( t )} )}^{α} + B \qquad ( 3 )$$

wherein Sₜₒₜ(t), t, A, B, p(t), α and β may be as stated above.

As indicated above the equation 3 may also be applied where the distribution of diffusivities D or inverse diffusivity 1/D is represented by respectively an inverse gamma distribution or a gamma distribution.

The determining the at least one characteristic parameter of the sample is based on the one or more of the fitting constants α and β, wherein the fitting constants α and β may be treated as and thus considered to be gamma constants. By applying the assumption that the diffusivities D of the particle species are gamma distributed and/or inverse gamma distributed the at least one characteristic parameter of the sample may be determined fully or partly determined based on the determined fitting constants α and β. To distinguish if a determination is based on the assumption that the diffusivities D of the particle species are gamma distributed and/or inverse gamma distributed or a combination thereof, it has herein been the where a determination of a characteristic parameter of the sample is based on the assumption that the diffusivities D of the particle species are gamma distributed the determination is said to be according to a route 1. By applying the assumption that the inverse diffusivities 1/D of the particle species are inverse gamma distributed or gamma distributed the at least one characteristic parameter of the sample is said to be determined according to a route 2. Further, by applying the assumption that the diffusivities D of the particle species are gamma distributed or inverse gamma distributed and that the inverse diffusivities 1/D of the particle species are inverse gamma distributed or gamma distributed, the at least one characteristic parameter of the sample may be determined according to a route a 3, wherein the route 3 comprises determining an average of a route 1 determination and a route 2 determination. The route 3 determination of the at least one characteristic parameter of the sample, may thereby be considered as a double determination, which may provide an even more accurate determination.

The background for applying the fitting equation 3 is based on the realization that the diffusivities D of the species of the sample may be assumed to be gamma distributed and/or the inverse diffusivities 1/D may be assumed to be inverse gamma or gamma distributed and may be explained as described in the following.

It has been found that a closed form solutions for Si(t) for a pulse of sample in a pressure driven pipe flow such as provided in FIDA may be described by the equation 4 (Gaussian distribution function):

$${S}_{i} ( t ) = {A}_{i} ( {D}_{i} ) \cdot exp ( \frac{- {( t - tr )}^{2} \cdot 12 \cdot {D}_{i}}{{R}_{c}^{2} \cdot tr} ) = {A}_{i} ( {D}_{i} ) \cdot exp ( - p ( t ) \cdot {D}_{i} ) \qquad ( 4 )$$

Where tr is peak appearance time (time to peak maximum), t is time, Di is the diffusion coefficient of the particle species i, R_{c} is the flow channel radius and Ai is related to a signal intensity (correlating with the amount) of particle species i. p(t) is as described above.

Equation 4 is valid under Taylor conditions applied for obtaining the Taylor dispersion signal profile.

Looking at a polydisperse sample with an arbitrary number of particle species, a distribution function may be applied to describe the distribution of particle species in solution. In the following, it is assumed that Ai is distributed according to different distributions giving rise to the total signal (Stot(t)) from the total of the plurality of particle species.

If there is only one particle species (n=1) the signal profile will be entirely described by equation 4 and any finite number (n) of particle species may be described by adding n Gaussian distributions (equation 4). However, if n is large (such as n>3) the uncertainty becomes significant and the sample may be better described by imposing a sample distribution function. An example of a distribution is the symmetric normal distribution or the log-normal distribution. However, such distributions does not allow for skewed non-symmetric distribution of particle species.

It has been found that the Gamma distribution allows for a very flexible particle species distribution characterization, and shall therefore assume a gamma distributed ensemble of particle species. In practice, each particle species is described according to equation 4. Assuming gamma distribution of diffusivities leads to:

$${A}_{i} ( {D}_{i} ) = A \cdot \frac{{β}^{α}}{Γ ( α )} \cdot {D}_{i}^{α - 1} \cdot {e}^{- β \cdot {D}_{i}} \qquad ( 5 )$$

Where A is the response factor α and β are the gamma distribution parameters and I is the gamma function.

As described more detailed below, the response factor may be a constant or a function of Di, depending on the sample and the marker.

Assuming up to an infinite number of particle species, combining equations 4 and 5 and inserting in equation 1 provides equation 6:

$${S}_{tot} ( t ) = {\int }_{0}^{∞} S ( t ) dD = A \cdot \frac{{β}^{α}}{Γ ( α )} {\int }_{0}^{∞} {D}^{α - 1} \cdot {e}^{- β \cdot D} \cdot {e}^{- p ( t ) \cdot D} d D \qquad ( 6 )$$

Where D may be used as an integration variable and the ensemble of diffusivities is assumed to be distributed in the interval 0 (zero) to ∞ (infinity).

The integral of equation 6 has the solution:

$${S}_{tot} ( t ) = A \cdot {( \frac{β}{β + p ( t )} )}^{α} \qquad ( 7 )$$

In practice, the measured signal may have a non-zero base line, which can be expressed as:

$${S}_{tot} ( t ) = A \cdot {( \frac{β}{β + p ( t )} )}^{α} + B \qquad ( 3 )$$

Thus, the constant B represents the baseline. In an embodiment B is zero.

The fitting may conveniently be performed by a computer or a computer system comprising two or more computers.

The instrument factor function p(t) may comprise an instrument factor as a function of time t. The instrument factor function may preferably be according to equation 8:

$$p ( t ) = \frac{{( t - tr )}^{2} \cdot 12}{{R}_{c}^{2} \cdot tr} \qquad ( 8 )$$

where tr is peak appearance time (time to peak maximum), t is time, R_{c} is the flow channel radius.

It has been found that the equation 8 describing the instrument factor function p(t) may be determined from the equation 4 above.

Advantageously, the fitting comprises fitting the plurality of data sets of the Taylor dispersion data. Each data set may represent a data point of the Taylor dispersion signal profile.

Preferably, the plurality of data sets comprises at least 5 data sets, such as 10 or more data sets. In an embodiment, the fitting comprises fitting data sets of at least 1 Hz (i.e. at least 1 data set per second) of the Taylor dispersion signal profile, such as fitting data points from 5 to 100 Hz.

It has been found that the fitting may be performed in a few seconds using, for example, a computer having 3.0-4.0 GHz processor.

As mentioned above it has been found that the diffusivities D of the plurality of particle species may be assumed to be gamma distributed and/or the inverse diffusivities 1/D of the plurality of particle species may be considered to be inverse gamma or gamma distributed.

In practice and for use of the method of the present invention it has been found that the diffusivities of the plurality of particle species may be estimated to be Gamma distributed and at the same time the inverse diffusivities 1/D of the plurality of particle species may be considered to be inverse gamma distributed or visa verse. Thereby the user may choose if the diffusivities of the plurality of particle species should be estimated to be Gamma distributed or if the inverse diffusivities of the plurality of particle species should be estimated to be to be inverse Gamma distributed or both, in the latter case the at least one characteristic parameter may be determined (route 3) as the average or the result obtained by using route 1 and route.

In an embodiment, wherein the Taylor dispersion signal profile of all species i in a species ensemble is estimated to adapt to a Gaussian distribution, and the distribution of diffusivities of the particle species is represented by a gamma distribution, the method comprises determining the fitting constants α and β of the gamma distribution and based on the fitting constants α and β determining the at least one characteristic parameter of the sample, wherein the at least one characteristic parameter comprises an average diffusivity Dₐᵥ.

It has been found that the average diffusivity conveniently may be determined according to the route 1 comprising applying the equation 9:

$${D}_{av} = α / β \qquad ( 9 )$$

In an embodiment, where the distribution of diffusivities is represented by a gamma distribution and the method comprises determining the fitting constants α and β and based on the fitting constants α and β determining the at least one characteristic parameter of the sample, wherein the at least one characteristic parameter comprises a variance of diffusivity var(D). It has been found that the variance of diffusivity var(D) may be determined according to the route 1 comprising applying the equation 10:

$$var ( D ) = α / ββ \qquad ( 10 )$$

In an embodiment, wherein the distribution of diffusivities of the particle species is represented by a gamma distribution and the method comprises determining the fitting constants α and optionally the fitting constant β and based on the fitting constant α and optionally the fitting constant β determining the at least one characteristic parameter of the sample, wherein the at least one characteristic parameter comprises a polydispersity index PDI of the readable particles.

It has been found that the PDI may be determined based on a alone according to the route 1 comprising applying the equation 11:

$$PDI = 1 / α \qquad ( 11 )$$

In an embodiment, the determination of the PDI is based on the average diffusivity Dₐᵥ and the variance of diffusivity var(D), optionally determined as described above; according to the route 1 comprising applying the equation 12:

$$PDI = var ( D ) / {D}_{av}^{2} \qquad ( 12 )$$

In an embodiment, the method further comprises obtaining the viscosity “n” of the sample. The viscosity of the sample is advantageously determined at same temperature as applied when obtaining the Taylor dispersion signal profile.

The viscosity of the sample may be determined using any method, e.g. the method described below, which may conveniently be performed simultaneously with the generation of the Taylor dispersion signal profile.

In an embodiment, wherein the viscosity “η” has been obtained and where the method comprises determining the fitting constants α and β, the at least one characteristic parameter of the sample comprises an average hydrodynamic radius Rh(av). The average hydrodynamic radius Rh(av) may advantageously be determined by applying the equation 13:

$${R}_{h} ( av ) = \frac{{k}_{B} \cdot T}{6 \cdot π \cdot η \cdot {D}_{av}} \qquad ( 13 )$$

wherein kb is Boltzmann constant, T is temperature of the sample in kelvin, η is the viscosity of the sample and Dₐᵥ is average diffusivity Dₐᵥ preferably determined as described above according to the route 1. In an embodiment Dₐᵥ may be determined according to route 1, according to route 2 or according to route 3.

In an embodiment, the distribution of inverse diffusivities (1/D) of the particle species is estimated to adapt to an Inverse Gamma the method may advantageously comprise determining the fitting constants α and β and the at least one characteristic parameter of the sample comprises an average diffusivity Dₐᵥ.

It has been found (from the properties of the gamma and inverse gamma distributions) that in this embodiment the average diffusivity Dₐᵥ may be determined according to the route 2 comprising applying the equation 14:

$${( 1 / D )}_{av} = β / ( α - 1 ) \qquad ( 14 )$$

This may be explained as follows:

In an embodiment, the equation may be represented by an inverse gamma distribution and wherein the method comprises determining the fitting constants α and β, the at least one characteristic parameter of the sample comprises a variance of diffusivity var(D).

It has been found that in this embodiment the variance of diffusivity var(D) may be determined according to the route 2 comprising applying the equation 15:

$$var ( 1 / D ) = ββ / ( {( α - 1 )}^{2} * ( α - 2 ) ) \qquad ( 15 )$$

In an embodiment, wherein the method of comprises obtaining the viscosity “η” of the sample e.g. as described above and determining the fitting constants α and β, the at least one characteristic parameter of the sample comprises an average hydrodynamic radius Rh(av).

In an embodiment, wherein the distribution of inverse diffusivities of the particle species is estimated to be represented by an inverse gamma distribution, the method comprises determining the average hydrodynamic Rh(av) according to the route 2 comprising applying the equation 16:

$${R}_{h} ( a v ) = \frac{{β}_{i n}}{1 - α} wherein {β}_{ln} = βk , \qquad ( 16 )$$

and k is dependent of the temperature T in Kelvin and the viscosity at that temperature K and may be is determined by

$$k = \frac{{k}_{B} \cdot T}{6 \cdot π \cdot η}$$

In an embodiment, where the inverse distribution of diffusivities of the particle species is represented by an inverse gamma distribution, each of the fitting equation 2 and the fitting equation 3 may be represented by an inverse gamma distribution and wherein the method comprises determining the fitting constants α and β the at least one characteristic parameter of the sample comprises a variance var(Rh) of the hydrodynamic radius.

It has been found that the variance var(Rh) of the hydrodynamic radius may be determined according to the route 2 comprising applying the equation 17:

$$Var ( Rh ) = \frac{{β}_{i n}^{2}}{( α - 2 ) {( α - 1 )}^{2}} wherein {β}_{ln} = βk , \qquad ( 17 )$$

and k may be determined as described above.

In an embodiment, wherein the inverse distribution of diffusivities of the particle species is estimated to adapt to an Inverse Gamma, the fitting equation may be represented by an inverse gamma distribution and wherein the method comprises determining the fitting constants α and β, the at least one characteristic parameter of the sample comprises
a polydispersity index PDI of the readable particles.

It has been found that the wherein the PDI may be determined according to the route 2 comprising applying the equation 18:

$$PDI = var ( Rh ) / {Rh ( av )}^{2} \qquad ( 18 )$$

From the above it will be clear for the skilled person that the at least one characteristic parameter of a sample of a substance comprising particles, such as one or more characteristic parameters of the samples may be determined by applying embodiment(s) of the method of the invention. In the foregoing it has been described how a number of desired characteristic parameters can be determined. It will be clear to the skilled person that further characteristic parameters may be determined e.g. based on the one or more of the above described desired characteristic parameters.

As mentioned above the distribution of diffusivities may be estimated to be gamma distributed and/or the inverse diffusivities 1/D of the plurality of particle species may be considered to be inverse gamma distributed In an embodiment, the method comprises determining the at least one characteristic parameter according to route 3 based on the assumption that the diffusivities D of the particle species are gamma distributed and that the inverse diffusivities 1/D of the particle species are inverse gamma distributed. The route 3 comprises performing a determination of the at least one characteristic parameter of the sample according to route 1, performing a determination of the at least one characteristic parameter of the sample according to route 2 and determining the average of the route 1 determination and the route 2 determination, to thereby obtaining a double determination of the at least one characteristic parameter. Thereby the resulting double determination of the at least one characteristic parameter may be even more accurate.

The Taylor dispersion signal profile may be as described above and may preferably comprise signals obtainable by a Taylor dispersion analysis of the sample in a channel, such as a capillary under a laminar Poiseuille flow, such as a hydrodynamic flow, wherein the response factor A is a factor of the measured signals, wherein the signals may be signals of an intrinsic marker or of an added (extrinsic) marker of one or more of the particle species.

Advantageously, the readable particles comprise markers, such as intrinsic or extrinsic markers capable of being detected. In an embodiment, the markers are optically readable markers, such as florescence markers and/or light absorbing markers.

The term “optical marker” is herein used to mean any intrinsic or extrinsic marker capable of being detected by an optical reader arrangement. In an embodiment, the marker comprises an element, group of elements, moieties and/or any combination comprising one or more of these, where the marker is capable of being detected by a reader arrangement directly and/or after being influenced from an external and/or internal source.

The marker may preferably be an intrinsic marker, such as an intrinsic fluorescent marker. Proteins are unique in displaying useful intrinsic fluorescence.

A useful intrinsic fluorescence of proteins is caused by three amino acid residues with aromatic side chains: phenylalanine, tyrosine and tryptophan. Out of these three, the latter are preferred to apply as intrinsic marker, because it has excitation and emission spectra having a relatively long wavelength (near the UV range) and a relatively long lifetime. These features simplify measurements of its fluorescence and allow for selective detection thereof.

In an embodiment, the readable particles are labelled with markers, such as fluorescent markers such as biological fluorophores (e.g., the green fluorescent protein), organic dyes (e.g., fluorescein) and fluorescent nanoparticles (e.g., quantum dots).

Where the marker(s) is a fluorescent marker(s), the marker(s) of the respective readable particles is advantageously exited and the emitted signal from the respective readable particles are recorded in a temporal frequency in dependence of the lifetime of the fluorescent marker.

Most fluorescence decays occur in a time window of ~100 fsec to nanoseconds, so measurements require short light pulses and high temporal resolution instrumentation. The lifetime of a fluorescent species can be determined from the decay of its fluorescence intensity as a function of time.

The Taylor dispersion signal profile may advantageously be recorded with a frequency of from 0.5-1000 Hz, such as from 1-100 Hz.

The signal factor A. depends on the reader instrument. Further, the signal intensity of the respective marker (e.g. fluorophore) may be attenuated by surrounding particles, e.g. larger particles. This is a well-known phenomenon in the art and may often be dealt with by an instrument calibration applying calibration samples with known particle composition.

The signal factor A may for example be determined by performing reading of signals from a sample comprising particles with a known signal emission, such as a known Taylor dispersion signal profile.

In an embodiment, the response factor A is constant and/or may be estimated to be constant. This may for example be in situations where the particles are labeled with the marker, such that the respective particle emits corresponding or even equal signals. Also, where the respective particle species have an equal amount or identical amount of intrinsic marker, such as amount of tryptophan, the response factor A is constant and/or it may be estimated to be constant.

In an embodiment, where the respective particle species differs in amount of intrinsic marker (such as amount of tryptophan) or added marker, the response factor A may not be a constant or may not be considered to be constant.

In an embodiment, where the respective particle species differs less than 10%, such as less than 5%, such as less than 1% of average in amount of intrinsic marker or added marker, the response factor A may be considered to be constant, since the potential error introduced based on such consideration may be insignificant.

Is some cases the marked particles may interact, such as polymerize or depolymerize and/or the marked particles may perform conformational change during the generation of the Taylor dispersion signal profile. Thereby the particle species of the readable particle may change during the generation of the Taylor dispersion signal profile.

In an embodiment, the response factor A is dependent on the diffusivity of the respective particle species of the sample. In this embodiment, it may be desired that the method comprises estimating the response factor to be gamma distributed in dependence of the diffusivity of the respective particle species.

This distribution may be caused by difference of signal intensity of the respective particles, such as a difference of more than 10% of average particle signal intensity. For example, where two particles have different molecule weight (MW), and thereby different intrinsic signal intensity.

In an embodiment, where two particles of a first particle species combine/bind to a common particle and thereby a second particle species, this common particle will now have a molecule weight (MW) that is higher than the individual two particles of the first particle species and in the same way, it will emit a higher signal than the respective particles of the first particle species.

In an embodiment, the factor A dependency of the diffusivity of the respective particle species of the sample may be caused by respective molecular weight of the respective particle species.

In an embodiment, the response factor A is estimated to be A and wherein the fitting equation represents a gamma distribution or an inverse gamma distribution described as

$${S}_{tot} ( t ) = \hat{A} \cdot {( \frac{β}{β + k ( t )} )}^{α} + B \qquad ( 3 a )$$

The estimated response factor Â may be estimated based on the MW distribution of the particle species.

In an embodiment, one or more of the particle species comprises a polymer composed on monomers each contributing to the response factor. Under those conditions, D (and Rh) could be dependent on the molecular weight (Mw). This may be expressed as a molecular weight dependence of A, meaning that A may not be treated as a constant but rather as the estimated Â. I.e. where the response factor A as a function of the diffusivity is as follows:

$$A ( D ) = a \cdot Mw$$

Wherein a is a numerical scaling factor describing how the response factor varies with molecular weight.

Further, molecular weight and diffusivity may be related according to:

$$b \cdot ln ( D ) = c \cdot ln ( Mw ) + ln K$$

wherein b, c and K are numerical constants that depends on the nature of the polymer species in the sample e.g. formed in the sample. This equation has for example been validated for proteins for example as described in the article “Protein intrinsic disorder in Arabidopsis NAC transcription factors: transcriptional activation by ANACo₁₃ and ANACo₄₆ and their interactions with RCD₁”, by Charlotte O'Shea et al. Biochem J (2015) 465 (2): 281-294 https://doi.org/10.1042/BJ20141045 and Uversky, V. N. (2002). Natively unfolded proteins: A point where biology waits for physics. Protein science Vol. 11, Issue 4, pages 739-756. https://doi.org/10.1110/ps.4210102.

This lead to the equation

$$Mw = {( \frac{1}{K} )}^{\frac{1}{c}} {( D )}^{\frac{b}{c}} Which lead to$$

$$A ( D ) = a \cdot {( \frac{1}{K} )}^{\frac{1}{c}} {( D )}^{\frac{b}{c}}$$

Not including base line contribution B, the total signal may then be expressed as follows:

$${S}_{tot} ( t ) = {\int }_{0}^{∞} S ( t ) dD = \frac{{β}^{α}}{Γ ( α )} {\int }_{0}^{∞} A ( D ) {D}^{α - 1} \cdot {e}^{- β \cdot D} \cdot {e}^{- p ( t ) \cdot D} dD$$

$${S}_{tot} ( t ) = a \cdot {( \frac{1}{K} )}^{\frac{1}{c}} \cdot \frac{{β}^{α}}{Γ ( α )} {\int }_{0}^{∞} {( D )}^{\frac{b}{c}} {D}^{α - 1} \cdot {e}^{- β \cdot D} \cdot {e}^{- p ( t ) \cdot D} dD$$

$${S}_{tot} ( t ) = \hat{a} \cdot \frac{{β}^{α}}{Γ ( α )} {\int }_{0}^{∞} {( D )}^{\frac{b}{c}} {D}^{α - 1} \cdot {e}^{- β \cdot D} \cdot {e}^{- p ( t ) \cdot D} dD Where$$

$$\hat{a} = a \cdot {( \frac{1}{K} )}^{\frac{1}{c}}$$

$${S}_{tot} ( t ) = \hat{a} \cdot \frac{{β}^{α}}{Γ ( α )} {\int }_{0}^{∞} {D}^{\hat{α} - 1} \cdot {e}^{- β \cdot D} \cdot {e}^{- p ( t ) \cdot D} dD Where$$

$$\hat{α} = α + b / c$$

$$In many cases , c = 1.$$

The above equation may be integrated as equation 6 leading to the equation:

$${S}_{tot} ( t ) = \hat{A} \cdot {( \frac{β}{β + p ( t )} )}^{\hat{α}} Where$$

$$\hat{A} = \frac{{β}^{α}}{Γ ( α )} \cdot \hat{a}$$

Taking into account a background signal/detector offset, the raw data can be described as equation 3a:

$${S}_{tot} ( t ) = \hat{A} \cdot {( \frac{β}{β + p ( t )} )}^{\hat{α}} + B$$

From appropriate curve fitting as described above, the characteristic parameter(s) defined above may then be determined as well as average size and polydispersity index.

It may be noted that a similar data processing may be used for the two cases. The response factor A may be estimated based on a calibration based on determinations on samples with known compositions. In an embodiment, wherein the response factor A is estimated to be Â, Â may be determined by a calibration using one or more calibration samples with known particle composition and concentration, estimated to correspond to the particle composition and concentration of the sample.

Alternatively, b/c may be treated as a fitting parameter.

Determining of the response factor A e.g. as the response factor is Â I known to a skilled person.

It therefore follows that the determination of Â may follow the same procedure as the determination A. It is advantageously in the post processing of data that the response factor dependence on diffusivities is taken into account.

The readable particles may comprise any number of particle species, including at least two different particle species. A particle species means herein particles having a common diffusivity. The two or more particle species are two or more species of particles with different diffusivities. The particle species may differ in diffusivity caused by having different molecule weight and/or by having different shape, for example proteins that differs in folding(s) and/or polymers that differs in branching.

The plurality of particle species may for example comprise at least four particle species, such as at least six particle species, such as at least 8 particle species, such as up to 100 particle species or more. It has been found that the method of the invention and embodiments thereof is particularly beneficial where the readable particles comprises many particle species, such as from 3 to 200 particle species, such as from 5 to 100 particle species, such as from 10 to 50 particle species.

In an embodiment, the plurality of particle species differs from each other in at least one physical or chemical parameter, such as at least one of molar weight, size, shape (e.g. protein folding), binding affinity in respect of another of the species.

Advantageously, the method comprises obtaining of the Taylor dispersion signal profile of the readable particles of the sample comprises performing a flow induced dispersion analysis (FIDA) and generating the Taylor dispersion signal profile by reading out signals from the particles and forming the Taylor dispersion signal profile. The generating of the Taylor dispersion signal profile may comprise exciting the intrinsic or extrinsic marker where it comprises a fluorescent marker followed by reading the emitted signals. The reading and/or exiting and reading may be performed by any suitable frequency e.g. as described above, such as frequency of from 0.5-1000 Hz, such as from 1-100 Hz.

The Taylor dispersion signal profile may advantageously be obtained, such as generate using a Fida 1 instrument marketed by Fida Biosystems Aps, DK

In an embodiment, the method comprises determining the viscosity (n) of the sample, preferably by performing a flow induced dispersion analysis (FIDA).

In an embodiment, the method comprises determining the viscosity of the sample comprising subjecting the sample to a pressurized laminar flow, determining a velocity parameter and correlating the velocity parameter to a calibration curve.

The phrase “pressurized laminar flow” means that the laminar flow of the sample in a channel, such as a capillary channel having an inner diameter of 1 mm or less, such as 0.5 mm or less and providing the sample to a laminar flow in the channel by applying a pressure from a channel inlet.

The viscosity may be calculated based on the time lapse from sample introduction in the channel via a channel inlet until the sample reaches a fixed detector, such as a detector located 2-50 cm downstream to the channel inlet to read signals from the particles. The viscosity is determined at a selected temperature, such as 37° C. and advantageously the instrument applied for performing the viscosity determination comprises a temperature control, such as the Fida 1 instrument discussed above.

The substance may in principle be any particle containing liquid, wherein the particles comprises readable particles as described above.

Advantageously, the substance comprises a biological liquid sample or a fraction thereof, such as a biological liquid sample from an individual. In an embodiment, the readable particles comprises polyclonal antibodies or polyclonal antibodies bound to a fluorescently labeled antigen.

The substance may for example comprise a biological sample comprising a polyclonal mixture of antibodies and optionally an antigen which may be added or forming part of the biological sample.

Antigen interaction with the polyclonal mixture of antibodies may then be analyzed. In this case, the “pdi” will reflect the distribution of affinities and provide a characterization of the strength of interaction between respective antibodies and the antigen. The greater the interaction, the stronger the affinity. Such a characteristic may be important for assessing immune responses

In an embodiment, the substance comprises nanoparticles, wherein the readable particles preferably comprises (potentially active) pharmaceutical ingredients, Solid lipid nanoparticles (SLNs), Lipid Nanoparticles (NLP's), Liposomes and/or Quantum dots (QD).

In an embodiment, the method of determining at least one characteristic parameter of a sample of a substance comprises determining a distribution of nanoparticles, such as the PDI of nanoparticles of the substance.

In an embodiment, the method of determining at least one characteristic parameter of a sample of a substance comprises determining a distribution sizes of LNP's (Lipid nanoparticles), such as the PDI of LNP's of the substance.

Lipid nanoparticle (LNP) are usually applied for delivery of pharmaceuticals e.g. for example for use in gene therapies, oncology and/or vaccines.

Particle size distribution, such a PDI may affect biodistribution and cellular uptake and the determination thereof may be useful in different stages of LNP development, production and quality control.

In an embodiment, the substance comprises proteins, such as solubilized membrane proteins, optionally solubilized using a solubilizing agents, e.g. a detergent, such as micelle-forming detergent(s)

In an embodiment, the method of determining at least one characteristic parameter of a sample of a substance comprises determining a distribution of sizes of detergent solubilized membrane proteins, such as the PDI of detergent solubilized membrane proteins of the substance.

Prior art methods of studying membrane proteins has been a major challenge in protein biochemistry and often involves careful isolation in the native form in a highly purified state. Using the method described herein provides a useful and relatively fast tool for understanding the structure and function of membrane proteins.

In an embodiment, the substance comprises viruses, such as Adeno Associated Viruses. Thereby valuable characteristic parameters may be determined, such as distribution of sizes of Adeno Associated Viruses and/or potential empty/full ratio, which may conveniently be applied in quality control testing.

An inherent characteristic of the AAV manufacturing process comprises production of capsids that are or are not packaged with a therapeutic transgene and are therefore referred to as respectively full or empty capsids.

In an embodiment, the method comprises quantitative or qualitative detection of formation of aggregates.

The method and embodiments thereof may beneficially comprise controlling a production of a selected species or a selected species composition, wherein the determined characteristic parameter is correlated to a reference parameter representing the selected species or a selected species composition.

All features of the invention(s) and embodiments thereof including ranges and preferred ranges can be combined in various ways within the scope of the invention, unless there are specific reasons not to combine such features.

### BRIEF DESCRIPTION OF THE EXAMPLES AND DRAWING

The invention is being illustrated further below in connection with examples and embodiments and with reference to the figures. The figures are schematic and may not be drawn to scale. The examples and embodiments are merely given to illustrate the invention and should not be interpreted to limit the scope of the invention

FIG. 1 is a screenshot of the Fida 1 instrument and illustrates data and Taylor dispersion signal profile associated to example 1a.

FIG. 2 is a screenshot of the Fida 1 instrument and illustrates data and Taylor dispersion signal profile associated to example 1b.

FIG. 3 is a screenshot of the Fida 1 instrument and illustrates data and Taylor dispersion signal profile associated to example 2.

FIG. 4a shows a plot of the Hydrodynamic radius (Rh) associated to example 3.

FIG. 4b shows a plot of the PDI associated to example 3.

### Example 1a

### Rh and PDI Determination Based on Taylor Dispersion Data

### AAV2 Preparation A.

The sample contained Adeno-associated virus type 2 (AAV2) of commercial origin (AAV 2 Null −1e12 p/ml—vendor specified concentration): The AAV2 contained intrinsic fluorescent proteins (Intrinsic tryptophan fluorescence) measurable by fluorescence detection. Taylor dispersion data and an associated Taylor dispersion signal profile of the readable particles of the sample was provided using a FIDA method applying a Fida 1 platform instrument marketed by Fida Biosystems Aps.

A plug of sample was injected into the flow channel between plugs of a buffer (PBS buffer pH 7.4).

The flow channel had an internal diameter of 75 micrometer and the flow was pressurized with a pressure of 100 mbar during the mobilization phase. The entire method is as described in the table 1 below:

TABLE 1

| | | |
|---|---|---|
| NaOH rinse | 3500 mbar | 60 sec |
| Buffer rinse | 3500 mbar | 40 sec |
| Analyte composition (Buffer) | 3500 mbar | 30 sec |
| Indicator injection(sample) | 50 mbar | 10 sec |
| Mobilize and measure | 100 mbar | 1000 sec |

Table 1 describes the different steps performed in the automated method using the Fida instrument.

The sample, which also constituted the indicator composition contained the AAV2 Null with the concentration 1e12 p/ml dissolved in PBS buffer, pH 7.4.

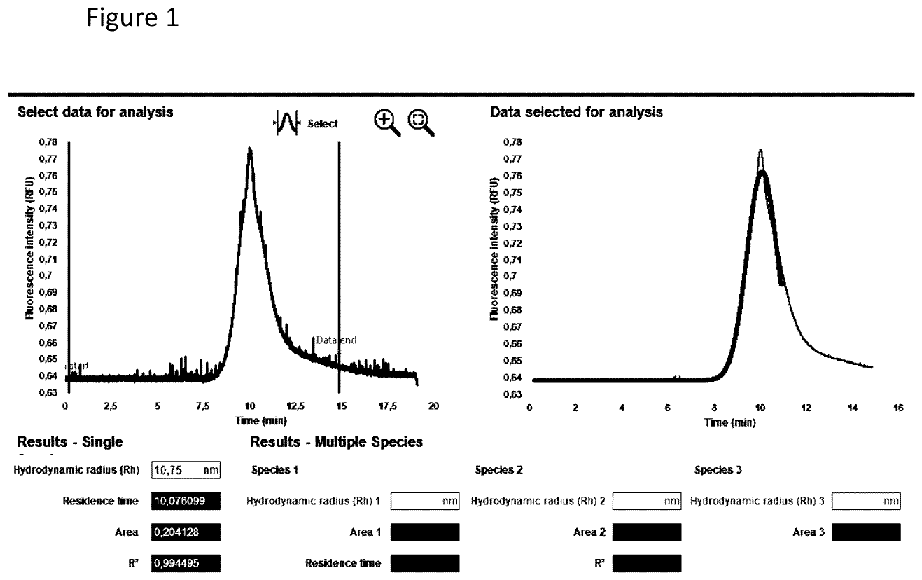

The analyte composition was the PBS buffer pH 7.4. The raw data for the Taylor dispersion signal profile is shown in FIG. 1 left image. The raw data was filtered from noise to generate the Taylor dispersion data and the Taylor dispersion signal profile generated from the Taylor dispersion data and applied for the analysis is shown in FIG. 1 right image.

The Fida instrument was programmed with the relevant equations as described above including the fitting equation 3 and equation 11. The Taylor dispersion data was fitted to the fitting equation (3) assuming that the response factor A was a constant or optionally gamma distributed in dependence of the diffusivity of the respective particle species in which case the response factor is A as explained above, which may be treated to be a constant and the fitting constants α and β were determined.

Assuming that the particle concentration dispersions in the sample is gamma distributed the following characteristics parameters of the sample were determined as described as described above.

PDI was determined to be 0.1 by applying the equation 11.

The average particle diameter was determined to be 21.6 nm.

The number of aggregates were determined using a spike counter program of the Fidabio software. Relatively low amounts of aggregates was observed: 46 in 40 nL=1·10⁶ aggregate/ml.

### Example 1b

### AAV2 Preparation B

Example 2 was performed as example 1 with the specification of table 1, wherein the sample, which also constituted the indicator composition contained the AAV2 Null with the concentration 1e12 p/ml dissolved in PBS buffer, pH 7.4.

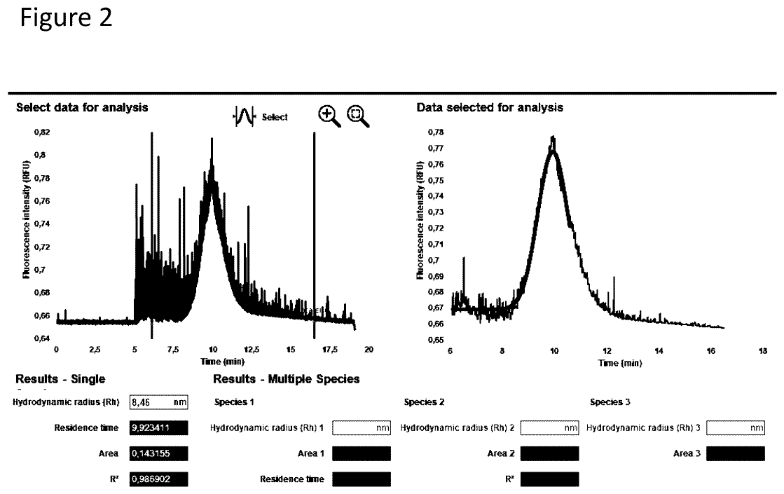

Analyte composition was the PBS buffer pH 7.4. The raw data for the Taylor dispersion signal profile is shown in FIG. 2 left image. The raw data was filtered from noise to generate the Taylor dispersion data and the Taylor dispersion signal profile generated from the Taylor dispersion data and applied for the analysis is shown in FIG. 2 right image.

The Fida instrument was programmed with the relevant equations as described above including the fitting equation 3, equation 9, equation 11 and equation 13. The Taylor dispersion data was fitted to the fitting equation (3) and the fitting constants α and β were determined.

Assuming that the particle concentration dispersions in the sample is gamma distributed, the following characteristics parameters of the sample were determined as described as described above.

PDI was determined to be approximately 0.1 by applying the equation 11.

The average particle diameter was determined to be 17 nm.

The Dₐᵥ was determined by applying the equation 9 and the Rh was determined by applying equation 13 to be 8.46 nm

The number of aggregates were determined using the spike counter program of the Fidabio software.

High amounts of aggregates was observed: 830 in 40 nL=2.1·10⁷ aggregate/ml. Despite the high amount of aggregates, it was possible to determine size and PDI.

### Example 2

Alexa-488 labeled affibody in fermentation media.

The affibody was purchased form Abcam and labeled using an alexa-488 maleimide dye (free thiol labeling).

Taylor dispersion data and an associated Taylor dispersion signal profile of the readable particles of the sample was provided as described in example 1a applying the method steps listed in table 2:

TABLE 2

| | | |
|---|---|---|
| NaOH rinse | 3500 mbar | 60 sec |
| Buffer rinse | 3500 mbar | 40 sec |
| Analyte composition | 3500 mbar | 30 sec |
| Indicator composition (Sample) | 50 mbar | 10 sec |
| Mobilize and measure | 400 mbar | 180 sec |

The sample was the indicator composition: Labeled Affibody in fermentation media.

Analyte composition was fermentation media without affibodi: fermentation media, pH 7.4.

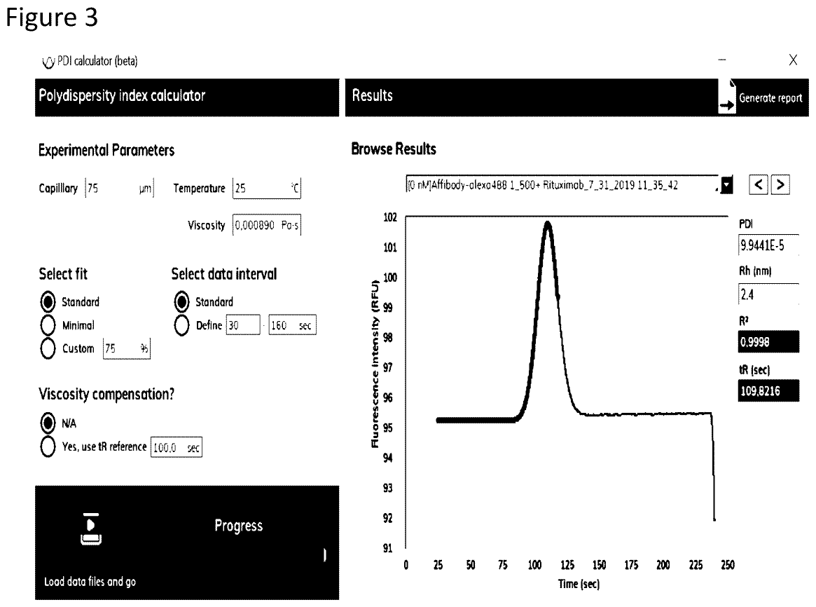

The Taylor dispersion signal profile is shown in FIG. 3

The Fida instrument was programmed with the relevant equations as described above including the fitting equation 3, equation 9, equation 11 and equation 13. The Taylor dispersion data was fitted to equation 3 and the fitting constants α and β were determined.

The size of the affibody is 2.4 nm, and the PDI is close to zero.

PDI was determined to be close to zero (9.9441E-5) by applying the equation 11. The affibody is accordingly determined to be a monodisperse sample.

The average particle diameter was determined to be 2.4 nm.

The Dₐᵥ was determined by applying the equation 9 and the Rh was determined by applying equation 13 to be 2.4 nm.

### Example 3

### Aggregated Albumin.

A mother sample comprising albumin intrinsic labeled and dissolved in PBS buffer (Phosphate Buffered Saline) (pH 7.4) was applied. The mother sample was heated to 90° C. and subsequently Taylor dispersion data and an associated Taylor dispersion signal profile on samples of the mother sample are measured was determined applying the Fida 1 instrument and 1 with the specification of table 2, at different points of time.

The samples of the mother sample were applied as indicator composition and as analyte composition the PBS buffer (pH 7.4) without albumin was applied.

The respective Taylor dispersion data determined for the respective samples of the mother sample at different point of time after the mother sample was subjected to the heating was analyzed by the Fida instrument which was programmed with the relevant equations as described above including the fitting equation 3, equation 9, equation 11 and equation 13. The respective Taylor dispersion data was fitted to equation 3 and the fitting constants α and β were determined.

PDI and Rh was determined by applying the equations 9, 11 and 13 as described above.

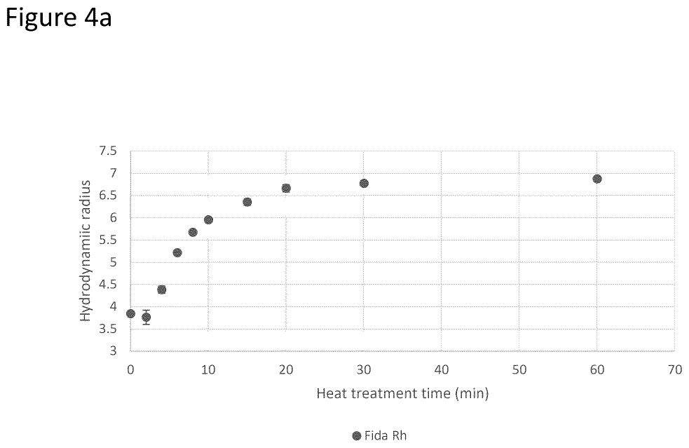

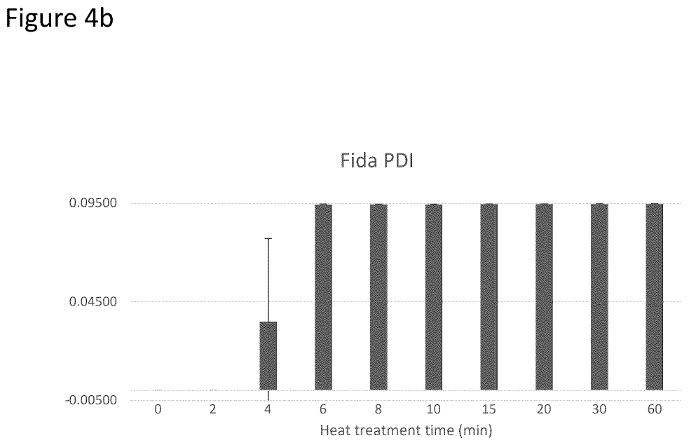

FIG. 4a shows a plot of the Hydrodynamic radius (Rh) as a function of time after the heat treatment of the mother sample.

FIG. 4b shows a plot of the PDI as a function of time after the heat treatment of the mother sample.

The examples shows how the heat induced aggregation process of albumin can be followed over time by measuring the evolution in Rh and PDI using the method of the invention.

Initially, a monodisperse sample is observed with a very low PDI, but over time the Rh and PDI increases in accordance with the aggregation process and it can be seen that at high temperature albumin aggregates leading to an increase in Rh and the PDI.

1. A method of determining at least one characteristic parameter of a sample of a substance comprising readable particles in a liquid, wherein the readable particles comprises a plurality of particle species, the method comprising
generating Taylor dispersion data comprising a plurality of data sets describing a Taylor dispersion signal profile of the readable particles of the sample, wherein the Taylor dispersion data has the formula
$${S}_{tot} ( t ) = {\int }_{0}^{∞} S ( t ) {dD}_{i} \qquad ( 1 )$$
wherein S(t) is the signal at the time t and Sₜₒₜ(t) is the total signal at the time t;
fitting the Taylor dispersion data to a gamma distribution based fitting equation, having a formula
$${S}_{tot} ( t ) = f ( p ( t ) ; α , β ) * A + B \qquad ( 2 )$$
wherein Sₜₒₜ(t) is the total signal at the time t, A is a response factor, B is a baseline constant, p(t) is an instrument factor function and α and β are fitting constants;
determining at least one of the fitting constants α and β; and
computing the at least one characteristic parameter of the sample based on the one or more of the fitting constants α and β.

2. The method of claim 1, wherein the generating of the Taylor dispersion data comprises
injecting the sample into a flow channel having a channel radius (R_{c});
conveying the sample under pressurized laminar Poiseuille flow through the flow channel;
recording, at a location along the flow channel and as a function of time (t), an optical or electrochemical signal emitted by an intrinsic or extrinsic marker of the readable and generating the Taylor dispersion data from the recorded optical or electrochemical signal,
wherein each of the plurality of data sets of the Taylor dispersion data describes a total signal at the time t (Sₜₒₜ(t)) of the Taylor dispersion signal profile.

3. The method of claim 1, wherein the instrument factor function comprises an instrument factor as a function of time t, wherein the method comprises determining the instrument factor function p(t) based on at least R_{c} and a peak-appearance time (tr) of the signal profile;
wherein the instrument factor function has the formula
$$p ( t ) = \frac{{( t - tr )}^{2} \cdot 12}{{R}_{c}^{2} \cdot tr} \qquad ( 8 )$$
where tr is the peak appearance time, t is time and R_{c} is the flow channel radius.

4. The method of claim 1, wherein the fitting equation is
$${S}_{tot} ( t ) = A \cdot {( \frac{β}{β + p ( t )} )}^{α} + B \qquad ( 3 )$$
where α and β are fitting constants.

5. The method of claim 1, wherein the method comprises determining the fitting constants α and β and wherein the method comprises determining the at least one characteristic parameter comprising at least one of
an average diffusivity Dₐᵥ, wherein Dₐᵥ is determined by applying equation 9:
$${D}_{a v} = α / β , \qquad ( 9 )$$
a variance of diffusivity var(D), wherein var(D) is determined by applying equation 10:
$$var ( D ) = α / ββ \qquad ( 10 )$$
and
a polydispersity index PDI of the readable particles of the sample, wherein the PDI is determined by applying equation 12:
$$PDI = var ( D ) / {D}_{av}^{2} . \qquad ( 12 )$$

6. The method of claim 1, wherein the method comprises determining the fitting constant α and wherein the method comprises determining the at least one characteristic parameter of the sample comprising a polydispersity index PDI of the readable particles, wherein the PDI is determined by applying equation 11:
$$PDI = 1 / α . \qquad ( 11 )$$

7. The method of claim 5, wherein the method comprises obtaining the dynamic viscosity “η” of the sample and determining the at least one characteristic parameter of the sample comprising an average hydrodynamic radius Rh(av), wherein Rh(av) is determined by applying equation 13:
$${R}_{h} ( a v ) = \frac{{k}_{B} \cdot T}{6 \cdot π \cdot η \cdot {D}_{a v}} \qquad ( 13 )$$
wherein kb is Boltzmann constant, T is temperature of the sample in kelvin, n is the viscosity of the sample and Dₐᵥ is average diffusivity Dₐᵥ, wherein Dₐᵥ.

8. The method of claim 1, wherein the method comprises determining the fitting constants α and β and, wherein the at least one characteristic parameter of the sample comprises
an average reciprocal diffusivity (1/D)ₐᵥ, wherein (1/D)ₐᵥ is determined by applying equation 14:
$${( 1 / D )}_{a v} = β / ( α - 1 ) \qquad ( 14 )$$
or a variance of reciprocal diffusivity var(1/D), wherein var(1/D) is determined by applying equation 15:
$$var ( 1 / D ) = ββ / ( {( α - 1 )}^{2} {}^{*} ( α - 2 ) ) . \qquad ( 15 )$$

9. The method of claim 1, wherein the method comprises obtaining the viscosity “η” of the sample, determining the fitting constants α and β and wherein the at least one characteristic parameter of the sample comprises an average hydrodynamic radius Rh(av), wherein Rh(av) is determined by applying equation 16:
$$\begin{matrix} & {R}_{h} ( a v ) = \frac{{β}_{i n}}{1 - α} \\ wherein & {β}_{l n} = β k , \\ and & \\ & k = \frac{{k}_{B} \cdot T}{6 \cdot π \cdot η}\end{matrix} \qquad ( 16 )$$
wherein k_{B} is Boltzmann constant, T is temperature of the sample in kelvin and η is the viscosity of the sample at the temperature T.

10. The method of claim 1, wherein the method comprises obtaining the viscosity “η” of the sample and determining the fitting constants α and β and wherein the at least one characteristic parameter of the sample comprises a variance var(Rh) of the hydrodynamic radius, wherein var(Rh) is determined by applying equation 17:
$$\begin{matrix} & Var ( Rh ) = \frac{{β}_{i n}^{2}}{( α - 2 ) {( α - 1 )}^{2}} \\ wherein & {β}_{l n} = β k , \\ and & \\ & k = \frac{{k}_{B} \cdot T}{6 \cdot π \cdot η}\end{matrix} \qquad ( 17 )$$
wherein k_{B} is Boltzmann constant, T is temperature of the sample in kelvin and η is the viscosity of the sample at the temperature T.

11. The method of claim 10, wherein the at least one characteristic parameter of the readable particles of the sample comprises a polydispersity index PDI of the readable particles, wherein the PDI is determined by applying equation 18:
$$PDI = var ( Rh ) / {Rh ( a v )}^{2} \qquad ( 18 )$$
wherein Rh(av) is determined by applying equation 16:
$$\begin{matrix} & {R}_{h} ( a v ) = \frac{{β}_{i n}}{1 - α} \\ wherein & {β}_{l n} = β k , \\ and & \\ & k = \frac{{k}_{B} \cdot T}{6 \cdot π \cdot η}\end{matrix} \qquad ( 16 )$$
wherein k_{B} is Boltzmann constant, T is temperature of the sample in kelvin and η is the viscosity of the sample at the temperature T.

12. The method of claim 1, wherein the readable particles comprises markers, such as intrinsic or extrinsic markers capable of being detected, wherein the markers are optically readable markers.

13. The method of claim 1, wherein the method comprises estimating the response factor A to be Â and
determining Â by fitting the Taylor dispersion data to a gamma distribution based response factor fitting equation described as
$${S}_{tot} ( t ) = \hat{A} \cdot {( \frac{β}{β + p ( t )} )}^{α} + B \qquad ( 3 a )$$
or
determining Â by a calibration using one or more calibration samples with known particle composition and concentration, estimated to correspond to the particle composition and concentration of the sample.

14. The method of claim 1, wherein the plurality of particle species comprises at least three particle species.

15. The method of claim 1, wherein the substance comprises a biological liquid sample.

16. The method of claim 1, wherein the substance comprises nanoparticles selected from the group comprising pharmaceutical ingredients, Solid lipid nanoparticles (SLNs), Lipid Nanoparticles (NLP's), Liposomes and/or Quantum dots (QD).

17. The method of claim 1, wherein the determining at least one characteristic parameter comprises quantitative or qualitative determination of formation of aggregates.

18. The method of claim 1, wherein the method comprises controlling a production of a selected species or a selected species composition, wherein the determined parameter is correlated to a reference parameter representing the selected species or a selected species composition.

19. A system for determining at least one characteristic parameter of a sample comprising readable particles dispersed in a liquid, the system comprising:
a flow channel having a known internal geometry and a channel radius (R_{c}) configured to receive the sample and to convey the sample under laminar Poiseuille flow;
a pressure source operatively coupled to the flow channel and configured to apply a controlled pressure to generate the laminar flow of the sample within the flow channel;
a temperature controller configured to maintain the sample within a selected temperature range during conveyance through the flow channel;
a detector positioned at a location along the flow channel and configured to record, as a function of time (t), an optical or electrochemical signal emitted by an intrinsic or extrinsic marker of the readable particles at a sampling frequency of at least 1 Hz to provide Taylor dispersion data comprising a plurality of data sets describing a Taylor dispersion signal profile Sₜₒₜ(t); of the readable particles of the sample, and
one or more processors configured for fitting the Taylor dispersion data to a gamma distribution based fitting equation, having a formula
$${S}_{tot} ( t ) = f ( p ( t ) ; α , β ) * A + B \qquad ( 2 )$$
wherein Sₜₒₜ(t) is the total signal at the time t, A is a response factor, B is a baseline constant, p(t) is an instrument factor function and α and β are fitting constants;
determine at least one of the fitting constants α and β; and
computing the at least one characteristic parameter of the sample based on the one or more of the fitting constants α and β.

20. The system of claim 19, wherein the one or more processors are configured for determining the instrument factor function p(t), comprising determining the instrument factor function p(t) based on at least R_{c} and a peak-appearance time (tr) of the signal profile;
wherein the instrument factor function has the formula
$$p ( t ) = \frac{{( t - tr )}^{2} \cdot 12}{{R}_{c}^{2} \cdot tr} \qquad ( 8 )$$
where tr is the peak appearance time, t is time and R_{c} is the flow channel radius.
